(19) United States
(12) Patent Application Publication
(10) Pub. No.: US 2019/0349098 A1
(43) Pub. Date: Nov. 14, 2019

(54) Radio Node Calibration

(71) Applicant: Telefonaktiebolaget LM Ericsson (publ), Stockholm (SE)

(72) Inventors: Zhiyuan Jiang, Beijing (CN); Mattias Frenne, Uppsala (SE); Qingyu Miao, Beijing (CN)

(21) Appl. No.: 16/466,821

(22) PCT Filed: Dec. 22, 2016
(86) PCT No.: PCT/CN2016/111475

§ 371 Date: Jun. 5, 2019

(51) Int. Cl. H04B 17/11; H04B 1/04

(52) U.S. Cl. CPC H04B 17/11; H04B 1/04

(57) ABSTRACT

This disclosure pertains to a method for operating a first radio node (100) in a radio access network. The method comprises performing a calibration of the first radio node (100) based on calibration signaling received from a second radio node (200) and based on calibration configuration information, the calibration configuration information being received from the second radio node (200). The disclosure also pertains to related devices and methods.

### TECHNICAL FIELD

The present disclosure pertains to wireless communication technology, in particular to over the air calibration of radio nodes.

### BACKGROUND

For radio nodes, in particular in reciprocity based multiple antenna transmission schemes, calibration is needed to enable reliable operation, in particular coherent transmit/receive beamforming, e.g. at the base station side. Specifically, the channel distortions introduced by different active components in respective transmit and receive RF (Radio Frequency) chains for a given antenna should be calibrated such that the distortions are compensated (e.g., directly at the antenna or at the baseband). To this end, different calibration techniques using a dedicated calibration network have been proposed.

### SUMMARY

It is an object of the present disclosure to provide approaches facilitating over the air (OTA) calibration of a radio node, in particular using calibration signaling transmitted from another radio node.

Accordingly, there is suggested a method for operating a first radio node in a radio access network. The method comprises performing a calibration of the first radio node based on calibration signaling received from a second radio node and based on calibration configuration information. The calibration configuration information is received from, and/or pertains to, the second radio node.

A first radio node for a radio access network is also disclosed. The first radio node is adapted for performing a calibration of itself based on calibration signaling received from a second radio node and based on calibration configuration information, the calibration configuration information being received from, and/or pertaining to, the second radio node. The first radio node may comprise processing circuitry and/or radio circuitry, and/or be adapted to use such for performing calibration and/or for receiving the calibration signaling and/or calibration configuration information. Alternatively or additionally, the first radio node may comprise a calibration module for performing calibration and/or a receiving module for receiving the calibration signaling and/or calibration configuration information.

It may be considered that the method comprises, and/or the first radio node is adapted for, transmitting, to the second radio node, a calibration request. Such transmitting may be performed before performing the calibration. Performing the calibration may be considered to be based on, and/or in response to, a calibration confirmation indication received from the second radio node, which may e.g. be transmitted by the second radio node in response to the calibration request. The first radio node may be adapted to use processing circuitry and/or radio circuitry for such transmitting. Alternatively or additionally, the first radio node may comprise a requesting module for such transmitting.

Alternatively or additionally, the method may comprise, and/or the first radio node may be adapted for, transmitting, to the second radio node, calibration setup information pertaining to the first radio node. The first radio node may be adapted to use processing circuitry and/or radio circuitry for such transmitting. Alternatively or additionally, the first radio node may comprise a setup transmission module for such transmitting.

The first radio node may generally be a radio node, in particular a network node. However, in some variant the first radio node may be a user equipment or terminal. Generally, the first radio node may be considered to be a radio node to be calibrated and/or a calibration target.

Moreover, there is described a method for operating a second radio node in a radio access network. The method comprises transmitting, to a first radio node, a calibration configuration to a first radio node.

A second radio node for a radio access network may be considered, the second radio node being adapted for transmitting, to a first radio node, a calibration configuration. The second radio node may be adapted to use processing circuitry and/or radio circuitry for such transmitting. Alternatively or additionally, the second radio node may comprise a configuration transmission module for such transmitting.

The method for operating a second radio node may comprise, and/or the second radio node may be adapted for, transmitting, to the first radio node, calibration signaling according to the calibration configuration. The second radio node may be adapted to use processing circuitry and/or radio circuitry for such transmitting. Alternatively or additionally, the second radio node may comprise a signaling transmission module for such transmitting. Transmitting calibration signaling may be after, and/or in response to, and/or based on, a confirmation indication and/or a request and/or calibration setup information, e.g. received from the first radio node.

Alternatively or additionally, the method for operating a second radio node may comprise, and/or the second radio node may be adapted for, transmitting, to the first radio node, a calibration confirmation indication, in response to a calibration request received from the first radio node. The second radio node may be adapted to use processing circuitry and/or radio circuitry for such transmitting. Alternatively or additionally, the second radio node may comprise a confirmation transmission module for such transmitting. Transmitting a calibration confirmation indication may be based on, and/or after, and/or in response to, a calibration request, which may be received from the first radio node, and/or based on channel conditions and/or traffic or load conditions.

The second radio node may generally be a radio node, in particular a user equipment. However, in some variant the second radio node may be a network node. Generally, the second radio node may be considered to be a radio node providing calibration signaling for calibrating a calibration target.

There is also disclosed a radio access system comprising a first radio node as described herein and a second radio node as described herein, as well as a method for operating a radio access system, the method comprising a method for operating a first radio node and a method for operating a second radio node as described herein, wherein the radio nodes may be interacting. The radio access system may be a radio access system as described herein.

Moreover, a program product comprising instructions is proposed. The instructions cause processing circuitry to perform and/or control any one of any combination of methods described herein. Instructions may be implemented as or in code. Instructions and/or code may be executable by the processing circuitry.

A carrier medium arrangement is considered, the carrier medium arrangement carrying and/or storing a program product as disclosed herein.

The approaches disclosed herein facilitate flexible calibration of a radio node, e.g. considering the calibration configuration information, and/or reliable over the air calibration. No specific calibration unit is required. The approaches also facilitate longer use cycles for the radio node, as the calibration may be performed without need to switch to a specific calibration unit, respectively may easily be performed without deviating significantly from normal operation.

Performing calibration may pertain to calibrating circuitry of the first radio node, in particular processing circuitry and/or radio circuitry and/or antenna circuitry. Performing calibration may comprise, and/or be based on, receiving calibration signaling. Calibration may comprise determining the behaviour of the radio node and/or circuitry when receiving, and/or the response thereof to, calibration signaling, and/or, in particular, determining deviation and/or non-linear behaviour and/or drift, e.g. temperature drift, and/or deviation from theoretical and/or ideal behaviour, and/or actual behaviour of the radio node or circuitry when receiving the calibration signaling. Such determining may comprise monitoring and/or measuring based on the calibration signaling, and/or e.g. determining signaling profile and/or behaviour profile, and/or comparing measured and/or monitored behaviour with a baseline or model, e.g. representing ideal or desired behaviour or response. It may be considered that calibration comprises determining and/or applying corrections, and/or correcting, and/or correcting for deviation, the response or behaviour to calibration signaling. Such correcting may comprise controlling the circuitry to change its behaviour and/or response, and/or considering deviation when processing and/or receiving (further and/or later) signaling, e.g. on the circuitry level and/or at higher levels. Calibration may generally comprise determining a channel matrix pertaining to the calibration signaling received.

The calibration may be performed individually, e.g. for one specific second node, or collectively, such that calibration is valid for signaling with more than one other node. It may be considered that a plurality of calibrations is performed, and different resulting corrections are used for different radio nodes. The calibrated circuitry (which may be corrected or correction for by other circuitry, e.g. by processing circuitry) may in particular comprise one or more receivers and/or a number of antennas, respectively associated circuitry. Calibration may be based on, and/or take into account other sources of deviation, e.g. related to transmission path/s and/or geometry. Associated information may be stored in a memory and/or obtained, e.g. based on measurements, which for example may be performed during setup and/or during operation. Reception of subsequent signaling may consider and/or be based on the calibration respectively its result and/or the determined correction.

A calibration configuration may represent a configuration of and/or for the first radio node. The calibration configuration may generally pertain to the calibration signaling and/or to the reception thereof by the first radio node. The calibration configuration may indicate transmission mode and/or resources and/or scheduling (which may be represented by scheduling information) and/or symbol pattern and/or physical characteristics and/or other characteristics of the calibration signaling, e.g. the antenna configuration/s used for transmitting the calibration signaling. It may be considered that the calibration configuration comprises characteristics of the transmitted calibration signaling, e.g. actual and/or theoretical and/or expected.

Physical characteristics of the calibration signaling may for example include waveform, and/or frequency and/or power and/or amplitude and/or polarization and/or direction, respectively associated distributions and/or profiles, e.g. time profiles.

The calibration configuration may for example indicate and/or comprise the density of the time/frequency resources of calibration signaling, and/or the periodicity of calibration signaling, and/or the trigger type for transmitting the calibration signaling (e.g., event-based or periodical). It may be considered that the calibration configuration comprises and/or indicates operation conditions, in particular channel conditions, and/or target transmission characteristics and/or deviations from ideal behaviour, e.g. due to known and/or stored in a memory and/or otherwise determined information. Such deviations may for example be due to non-linear behaviour of the radio and/or antenna circuitry used for transmitting the calibration signaling, and/or due to drift, e.g. temperature drift or drift due to age, other deviation due to characteristics of the circuitries.

A calibration configuration may generally indicate or represent the channel matrix of the calibration signaling in transmission (at the transmitting node or antenna) and/or to be expected to be received. Such a channel matrix may be considered to represent, and/or to be determined based on, the conditions and/or characteristics and/or parameters and/or settings mentioned herein.

The transmission mode may pertain to the coding and/or modulation and/or transmission or signal format and/or beamforming scheme for the calibration signaling.

The calibration configuration may be configured to the first radio node, e.g. by the second radio node.

Generally, the calibration configuration information may pertain to, and/or represent the calibration configuration or part or one or more parameters thereof, and/or may enable the first radio node to perform the calibration.

Performing calibration based on calibration configuration information may comprise configuring the first radio node (e.g., by itself) according to the information and/or for operation in the configuration indicated by the calibration configuration information.

It may be considered that the calibration configuration comprises and/or represents whether the second radio node needs calibration itself (e.g., in reciprocity).

The calibration configuration may be (at least partly) based on information received from the first radio node, e.g. configuration data and/or a request and/or scheduling information and/or calibration setup information. The second radio node may be adapted for, and/or the method for operating it may comprise, determining the calibration configuration and/or corresponding information accordingly, e.g. by using the processing circuitry and/or a configuration module. It should be noted that the first and second node may perform operations based on the calibration configuration, which may be represented by different information and/or parameters for the different nodes, which may be related to their respective operations (in particular, transmission of calibration signaling or performing calibration based on such signaling). For a calibration setup an analogous reasoning holds.

In particular in the context of reciprocity, but not limited thereto, a calibration configuration may correspond to, and/or represent, and/or be based on, a calibration setup.

A calibration setup may pertain to a setup of the first radio node for calibration and/or receiving calibration signaling. The setup may pertain to one or more antenna configurations and/or capabilities and/or calibration requirements or targets of the first radio node, and/or operation conditions, e.g. channel conditions and/or movement status, e.g. represented by speed and/or velocity. The antenna configuration/s may pertain to the antennas used for reception of the calibration signaling. Channel conditions may be determined based on measurements (e.g. performed by the first radio node), and/or reports from the second radio node, e.g. included in the calibration configuration.

It may be considered that first radio node is adapted for, and/or the method for operating this node, comprises updating and/or adapting the calibration setup based on the calibration configuration information, e.g. to configure the first radio node for calibration. Performing calibration may utilise the adapted or updated setup, which may be considered a configuration of the first radio node.

Scheduling or related information may indicate resources and/or a signal or symbol pattern to be used. Channel conditions may pertain to transmission quality and/or signal quality and/or interference, e.g. represented by SNR, SIR or SINR or path loss.

A calibration configuration or setup may be variable over time, e.g. regarding power and/or waveform and/or antenna configuration, which may be represented by a calibration configuration indicating associated time profiles and/or timings, and/or different subconfigurations, in particular regarding antenna configurations.

Resources may be scheduled, e.g. by the one of the radio nodes, in particular a network node, e.g. when determining the calibration configuration. Resources in this context may for example comprise time-frequency resources (e.g., in the form of resource elements or resource blocks) and/or transmission power or mode and/or code and/or modulation and coding scheme and/or number of antennas and/or beamforming scheme used.

Capabilities of a node may generally pertain to reception or transmission capabilities and/or class (e.g., transmission or power class). Reception or transmission capabilities of a radio node may pertain to resolution (e.g, time and/or frequency and/or power) and/or non-linearity and/or possible deviations (e.g., maximum and/or minimum and/or average) deviations from ideal and/or target behaviour.

The calibration configuration information may generally indicate and/or represent and/or be associated to a, or a part of a, calibration configuration, e.g. of the second radio node. Calibration configuration information may in particular represent a suitable parametrisation, e.g. sutiable for use by the first or second radio node.

Calibration setup information may generally indicate and/or represent and/or be associated to a, or a part of a, calibration setup, e.g. of the first radio node. Calibration setup information may in particular represent a suitable parametrisation, e.g. suitable for use by the first or second radio node.

Signaling may generally comprise one or more signals and/or symbols, and/or may cover a suitable transmission time interval (TTI) having one or more symbol time lengths. Calibration signaling may in particular comprise one or more calibration and/or reference symbols or signals. Calibration signaling may be or comprise and/or be based on operation or transmission characteristics like OFDM (Orthogonal Frequency Division Multiplexing) and/or DFTS-OFDM (Discrete Fourier Transform Spread OFDM), and/or it may be TDD (Time Division Duplex) or FDD (Frequency Division Duplex) based. TDD is particularly suitable for reciprocity-based approaches, e.g. using the same frequency be used for both transmissions (of calibration signaling, which in reciprocity is used by each radio node). However, the approaches described herein may be beneficially implemented in the context of FDD as well. Calibration signaling may in particular transmitted as beamformed signaling. Transmission characteristics may generally comprise physical characteristics and/or transmission mode or scheme.

Transmitting calibration signaling according to a calibration configuration may comprise utilising the calibration configuration for the transmitting and/or transmitting to comply with the calibration configuration, and/or configuring the transmitting radio node accordingly. The calibration configuration may be variable during transmitting, e.g. according to a time variable configuration, which may in particular relatw to antenna configurations. For example, during calibration signaling, different power profiles and/or antenna ports may be used.

A calibration request may comprise information indicating that the requesting (e.g., the first radio node) node intends to initiate calibration, e.g. implicitly and/or explicitly, for example comprising one or more indicator bits. A request may comprise and/or be implemented as a message. It may be considered that a request comprises calibration setup information and/or information pertaining to the calibration configuration, in particular scheduling information pertaining to resources scheduled for calibration signaling. In reciprocity, e.g. when the first radio node and second radio node are used both for being calibrated and providing calibration signaling for each other, a calibration configuration may represent a (e.g., implicit) calibration request, e.g. indicating that the node transmitting the calibration configuration information needs calibration itself.

A calibration setup may generally pertain to the configuration or setup of the first radio node to be used and/or intended for use for calibration. A calibration setup may generally comprise or indicate one or more calibration targets.

A calibration confirmation indication may indicate that the second radio node is acknowledges (or rejects) the calibration, and/or will transmit the calibration configuration and/or the calibration signaling.

An antenna configuration may represent and/or pertain to the number of antennas used and/or sweeping state or profile (of a beam) and/or beamforming state (beam or shape of the beam used), and/or antenna port (e.g., to be used for transmitting and/or receiving), etc.

A radio node may generally be considered a device or node adapted for wireless and/or radio (and/or microwave) frequency communication, and/or for communication utilising an air interface, e.g. according to a communication standard.

A radio node may be a network node, or a user equipment or terminal. A network node may be any radio node of a wireless communication network or RAN, e.g. a base station and/or gNodeB (gNB, a base station for NR) or eNodeB and/or relay node and/or micro/nano/pico/femto node and/or other node, in particular for a RAN as described herein. For an implementation of the radio node as network node.

The terms user equipment (UE) and terminal may be considered to be interchangeable in the context of this disclosure. A user equipment or terminal may represent and end device for communication utilising the wireless communication network, and/or be implemented as a user equipment according to a standard. Examples of user equipments may comprise a phone like a smartphone, a personal communication device, a mobile phone or terminal, a computer, in particular laptop, a sensor or machine with radio capability (and/or adapted for the air interface), in particular for MTC (Machine-Type-Communication, sometimes also referred to M2M, Machine-To-Machine), or a vehicle adapted for wireless communication. A user equipment may be mobile or stationary.

A radio node may generally comprise processing circuitry and/or radio circuitry. Circuitry may comprise integrated circuitry. Processing circuitry may comprise one or more processors and/or controllers (e.g., microcontrollers), and/or ASICs (Application Specific Integrated Circuitry) and/or FPGAs (Field Programmable Gate Array), or similar. It may be considered that processing circuitry comprises, and/or is (operatively) connected or connectable to one or more memories or memory arrangements. A memory arrangement may comprise one or more memories. A memory may be adapted to store digital information. Examples for memories comprise volatile and non-volatile memory, and/or Random Access Memory (RAM), and/or Read-Only-Memory (ROM), and/or magnetic and/or optical memory, and/or flash memory, and/or harddisk memory, and/or EPROM or EEPROM (Erasable Programmable ROM or Electrically Erasable Programmable ROM). Radio circuitry may comprise one or more transmitters and/or receivers and/or transceivers (which may be operable as transmitter and receiver), and/or may comprise one or more amplifiers and/or oscillators and/or filters, and/or may comprise, and/or be connected or connectable to antenna circuitry and/or one or more antennas. A radio node may comprise, and/or be connected or connectable to antenna circuitry and/or a plurality of antennas, in particular a number of antennas which is a power of 2. The antennas may be at least in part independently controllable. It may be considered that a radio node is adapted to utilise a controllable number of the number of antennas for transmitting and/or receiving, e.g. controllable by radio circuitry and/or processing circuitry. The controllable number may dependent on the calibration setup or calibration configuration. Antenna circuitry may generally comprise one or more antennas and/or associated circuitry, in particular integrated circuitry, e.g. one or more preamplifiers and/or filters and/or converters.

A radio node may be implemented to combine the features of a first radio node as described herein and a second radio node as described herein, being operative as either or both, e.g. for reciprocity operation with another radio node, which also may be implemented as a first and/or second radio node.

Any one or all of the modules disclosed herein may be implemented in software and/or firmware and/or hardware, e.g. circuitry described herein. Different modules may be associated to different components of a radio node, e.g. different circuitries or different parts of a circuitry. It may be considered that a module is distributed over different components, and/or that functionality of one module is distributed to and/or provided by more than one module. One module may provide the functionality associated to different modules, which thus may be referred to by different terms.

A wireless communication network may be a Radio Access Network (RAN), in particular according to a communication standard. A communication standard may in particular a standard according to 3GPP and/or 5G, e.g. according to NR or LTE Evolution. A RAN may generally be a RAN according to NR or LTE Evolution.

### BRIEF DESCRIPTION OF THE DRAWINGS

The drawings are provided to illustrate concepts and approaches disclosed herein, and are not intended to limit their scope unless specifically stated. The drawing comprise:

FIG. 1, showing a flow diagram of example methods of operating radio nodes interacting;

FIG. 2, showing an exemplary radio node;

FIG. 3, showing a flow diagram of an exemplary method for operating a first radio node;

FIG. 4, showing an exemplary first radio node;

FIG. 5, showing a flow diagram of an exemplary method for operating a second radio node; and

FIG. 6, showing an exemplary second radio node.

### DETAILED DESCRIPTION

Most current base station products adopt dedicated circuits, namely a calibration network or calibration unit, for reciprocity calibration. An additional calibration port is added as a reference. The calibration is done by transmitting/receiving on the calibration port to/from different antenna ports, and after the measurement, the relative phase and delay differences across different antenna branches are compensated to achieve coherent beamforming. In the following, it may be referred to a network. Such a reference may be considered to pertain to a network node, which may be operating as first or second radio node.

Over-the-air reciprocity calibration may be considered instead. Specifically, for two stations (Node A and B, e.g. a first radio node A and a second radio node B) of a point-to-point link, a sketch of the method to perform calibration of the TX/RX (Transmitter/Receiver) in Node A may comprise:

1. Node A transmits RSs (Reference Signals as example of calibration signaling) on each antenna port, based on which Node B estimates the channel matrix from A to B, i.e.,

2. Node B feeds back explicitly the channel matrix, i.e., H_{AB} from Node B to Node A

3. Node B transmits RSs on each antenna port, based on which Node A estimates the channel matrix from B to A, i.e., H_{BA}.

4. Based on H_{AB} and H_{BA}, which are both available at Node A, the calibration parameters are calculated and applied in the beamforming of Node A.

Such a method does not require any specific hardware, e.g., calibration network, but can be only applied to point-to-point links (but may be applied to multiple such links).

Current calibration methods are typically one sided, using calibration networks. In particular with the increased availability of radio nodes with multiple antenna elements, e.g. the advent of up to 64 antenna elements at the UE, and in some cases increased use for reciprocity, calibration of both the network side and the UE side of a link is desirable for optimal performance.

Hence, it is a problem how to calibrate both sides of a link between two nodes, A and B without introducing additional calibration hardware, i.e. a calibration network.

Current calibration network solutions show problems like:

1. The calibration network requires additional, dedicated hardware, and hence has more cost and less flexibility. This is a burden, especially for UE implementations which are more cost sensitive.

2. The calibration network can only achieve relative reciprocity, in the sense that the uplink and downlink channels are not exactly reciprocal, but within a complex constant caused by the use of an external calibration port.

3. The UE side is typically not calibrated since it is usually too much cost to implement a calibration network on UE device specially if the number of antennas becomes very large as in NR where up to 64 UE antennas has been discussed.

There is proposed a flexible configuration method in particular for using over-the-air reciprocity calibration in cellular systems. The calibration configuration may generally include and/or indicate whether or not a UE (as first radio node) needs calibration, the density of the time/frequency resources for calibration, the periodicity of calibration, and the trigger type of the calibration (event or periodical). A protocol is proposed to exchange the information between two sides of a link (representing first and second radio nodes, which may reverse their roles in reciprocity). The link can be one between a UE and a BS (Base Station), a backhaul link, or a relay link.

The advantage of the proposed solution is that it allows different calibration configurations based on radio node, in particular UE, requirements/capabilities, intended transmission schemes, channel conditions and base station capabilities, thus making over-the-air reciprocity calibration applicable in cellular systems where UEs of different types and capabilities exists.

It is observed that the different UEs in cellular systems can have different requirements for calibration, such that different UEs may use similar calibration methodology but with different calibration targets or configurations.

Examples of different calibration requirements (representing a calibration configuration or part thereof) for UEs (considered to be a first radio node to be calibrated herein) relate to:
Some UEs may require more calibration resource allocation because their channel condition is poor (such as high speed UEs; the speed of a UE may be a calibration setup characteristic of a UE operating as first radio node). The calibration resource/s may be defined as the time and frequency resource elements used by calibration operation (transmitting of calibration signaling). These UEs may require more resource to obtain appropriate calibration. More resources may also be needed for UEs with a large number of antennas, compared to those with a small number of antennas. The required calibration resource may change over time, hence the calibration resource may be adapted to the speed or other conditions of the link such as SNR (which may represent channel condition). For this purpose, dedicated signaling to the UE may be used to control the amount of resources used for calibration.
For some UEs, calibration can be less frequent, such as a UE with high RF quality, or low speed. Too frequent calibration will bring too much overhead. For some UE, calibration can be very frequent due to low cost RF. Hence, the calibration frequency or resource need may depend on the UE category or on the UE capability. The category and/or capability may be signaled from the UE to the network so that the correct calibration resources can be configured to the UE.
Some UEs do not require reciprocity calibration if they are in the open-loop beamforming mode. For example, for UEs at a cell edge, there is no gain with reciprocity due to limited uplink coverage for SRS (Sounding Reference Signaling, a form of reference signaling), etc. For low cost and low traffic UEs (MTC), there is no requirement to use reciprocity to boost the capacity, etc. Hence, also in this case, the calibration frequency or resource need may depend on parameters like the UE category and/or on the UE capability and/or on the configured transmission mode (such as coverage extension, and/or open loop beamforming). The category and/or capability may be signaled from the UE to the network so that the correct calibration resources can be configured to the UE. The use of a transmission scheme (e.g. open loop beamforming) is determined by the serving network and the network then configures the necessary amount of calibration resources (or no calibration at all) accordingly.
Some UEs that take part in receiving and/or transmitting advanced MU-MIMO (Multi-User, Multiple Input-Multiple Output) precoding may need higher resolution calibration and thus need more resources. If the precoding is simpler, such as using DFT vectors to obtain a grid of beams, the need for calibration is less, and thus less calibration resources are needed. Hence, there is a need to adapt the calibration resources depending on the current use case, respectively antenna configuration.
For some UEs or other radio nodes, there is no requirement on the OTA calibration, For example, for a relay node/self backhaul node, the coupling network can also be used in the UE side. For some analog beamforming approaches, the online calibration is not needed, which can be calibrated in the factory. Related conditions or requirements can also be signaled by the UE category or UE capability from the UE to the network.

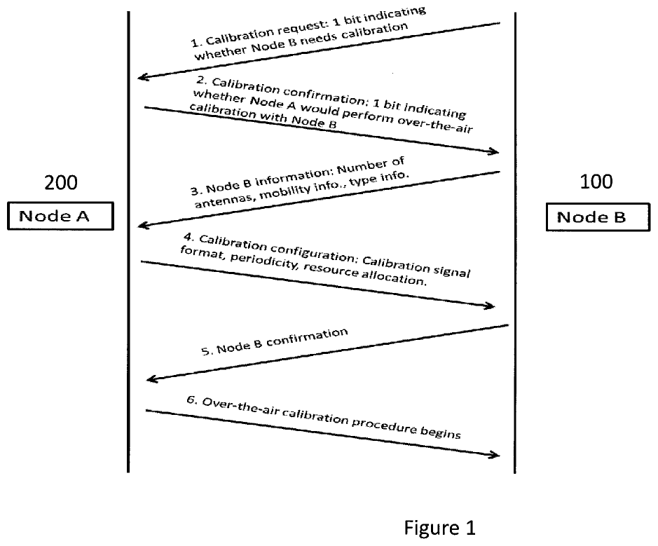

A flowchart of a proposed calibration configuration protocol is shown in FIG. 1.

1. Node B (the first radio node 100) initializes the calibration procedure. For a backhaul link, Node A and Node B can both represent base station sites and/or network nodes. For a relay link, Node B can be a relay. Node B can also be a mobile or UE, and Node A (the second radio node 200) may be a network node like a base station in this case. Node B sends a calibration request indicating whether or that it requires a calibration procedure. In some cases, e.g., massive machine-type-communications, Node B may not need reciprocity calibration since only a small data rate is required.

2. Node A responds with a confirmation, e.g. a bit, indicating whether Node B shall continue to proceed with calibration. Node A may make the decision based on

a) whether Node A is already calibrated using a calibration network, and whether there is need for over-the-air calibration given the circumstances; and/or

b) whether Node A is capable of reciprocity based operations, and/or

c) given Node B's conditions, e.g., channel conditions and traffic requirements, whether calibration shall be performed.

3. Node B feeds back information about itself, including e.g., number of calibration antennas (antenna configuration), type of the equipment (capability) and mobility information (operation condition), or more generally, provided information.

4. Node A sends out the calibration configuration, including the e.g. configuration signal format, resource allocation, periodicity, RS sequence information.

5. Node B confirms the allocation.

6. The calibration procedure starts with transmitting the calibration signaling.

The individual parts of the above signaling or protocol are optional.

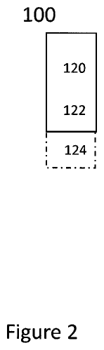

FIG. 2 shows an exemplary radio node 100, which may be implemented as network node or UE, e.g. as a network node like a base station or relay station or any radio access node, which in particular may be an eNodeB or gNB or similar for NR. Radio node 100 comprises processing circuitry (e.g. control circuitry) 120, which may comprise a controller connected to a memory. Any module of the radio node 100 may be implemented in and/or executable by the processing circuitry 120, e.g. in software and/or hardware and/or firmware. The processing circuitry 120 is connected to control radio circuitry 122 of the radio node 100, which provides receiver and transmitter and/or transceiver respectively corresponding functionality. An antenna circuitry 124 may be connected or connectable to radio circuitry 122 for signal reception or transmittance and/or amplification. The radio node 100 may be adapted to carry out any of the methods for operating a radio node disclosed herein; in particular, it may comprise corresponding circuitry, e.g. processing circuitry. The antenna circuitry may be connected to and/or comprise a plurality of antennas, e.g. an antenna array.

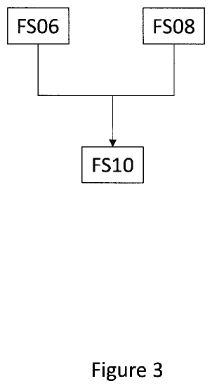

FIG. 3 shows a diagram for an exemplary method for operating a first radio node. The method comprises an action FS10 of performing a calibration of the first radio node based on calibration signaling received from a second radio node and based on calibration configuration information, the calibration configuration information being received from, and/or pertaining to, the second radio node. Generally, information pertaining to the calibration signaling and/or the calibration configuration of the second radio node may be considered information pertaining to the second radio node. The method may optionally comprise an action FS06 of transmitting, to the second radio node, a calibration request, e.g., before action FS10. Alternatively or additionally, the method may comprise an action FS08 of transmitting, to the second radio node, calibration setup information pertaining to the first radio node.

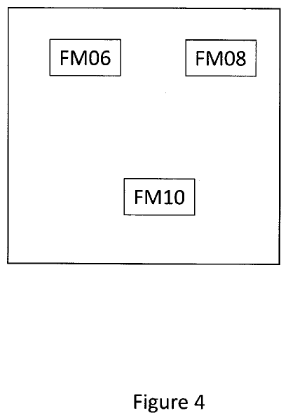

FIG. 4 shows an exemplary first radio node. The first radio node may comprise a calibration module FM10 for performing action FS10. Optionally, the first radio node may comprise a requesting FM06 for performing action FS06, and/or a setup transmission module FM08 for performing action FS08.

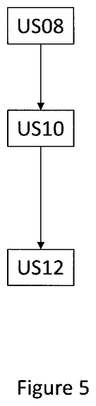

FIG. 5 shows a diagram for an exemplary method for operating a second radio node. The method may comprise an action US10 of transmitting, to a first radio node, calibration configuration information to a first radio node. The calibration configuration information may generally be based on a calibration configuration. The method may optionally comprise an action US12 of transmitting, to the first radio node, calibration signaling according to a calibration configuration the calibration configuration information pertains to. Further optionally, the method may comprise an action US08 of transmitting, to the first radio node, a calibration confirmation indication, in response to a calibration request received from the first radio node.

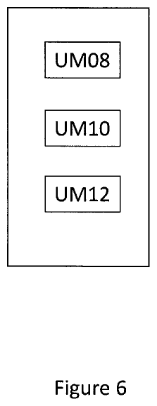

FIG. 6 shows an exemplary second radio node. The second radio node comprises a configuration transmission module UM10 for performing action US10. Optionally, the second radio node may comprise a signaling transmission module UM12 for performing action US12. Further optionally, the second radio node may comprise a confirmation transmission module UM08 for performing action US08.

The calibration configuration can indicate calibration as a one-time event, or periodical calibration, e.g. depending on the requirements of the first radio node.

The configuration includes the frequency (every 10 s or every 100 ms). These can be decided by UE or network. For some UEs, calibration can be less frequent (UE with high RF quality, low speed and etc.). Too frequent calibration will bring too much overhead. For some UEs, calibration can be done very frequently.

The calibration configuration may include a number of resources used for calibration. Some calibration signaling may be transmitted together with data signaling. For some application, more resources to achieve accurate calibration may be needed, e.g. for high speed UEs and/or others that need specific filtering and averaging of the channels.

There is proposed a flexible configuration method for an over-the-air reciprocity calibration. There may be considered exchanging capabilities between Node A and Node B, disclosing the need for calibration and possibly also the frequency/granularity of the calibration

Configuring the calibration signaling (e.g., RS) needed from Node A and Node B to achieve over-the-air reciprocity calibration by signaling between Node A and Node B or vice versa for different types of equipment may be considered, including e.g. relay, fixed wireless links and mobile users.

Dynamically changing the calibration operation such as RS density depending on the use cases may be considered, e.g. based on speed, SNR, used transmission scheme or mode (for example open loop, closed loop, SU-MIMO, MU-MIMO, beam based operation, advanced precoding operation)

In the context of this disclosure, the terms “first” and/or “second” are not intended, unless specified otherwise, to imply that more than one (e.g., radio node) is referred to. For example, the first radio node and second radio node as discussed herein are independent devices, and may be implemented individually (although perhaps being adapted for operating with another node).

A radio access network (RAN) may be any kind of cellular and/or wireless radio network, which may be connected or connectable to a core network. The approaches described herein are particularly suitable for a 5G network, e.g. advanced LTE/LTE Evolution and/or NR (New Radio), respectively successors thereof. A RAN may comprise one or more network nodes. A network node may in particular be a radio node adapted for radio and/or wireless and/or cellular communication with one or more terminals. A terminal may be any device adapted for radio and/or wireless and/or cellular communication with or within a RAN, e.g. a user equipment (UE) or mobile phone or smartphone or computing device or vehicular communication device or device for machine-type-communication (MTC), etc. A terminal or UE may be mobile, or in some cases stationary.

Transmitting in downlink may pertain to transmission from the network or network node to the terminal. Transmitting in uplink may pertain to transmission from the terminal to the network or network node.

A carrier medium arrangement may comprise one or more carrier media. Generally, a carrier medium may be accessible and/or readable and/or receivable by control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

Configuring (e.g., with or for a configuration) a device like a terminal or network node may comprise bringing the device into a state in accordance with the configuration. A device may generally configure itself, e.g. by adapting a configuration. Configuring a terminal, e.g. by a network node, may comprise transmitting a configuration or configuration data indicating a configuration to the terminal, and/or instructing the terminal, e.g. via transmission of configuration data, to adapt the configuration configured.

Resources or communication resources or radio resources may generally comprise frequency and/or time resources (which may be called time-frequency resources). Allocated or scheduled resources may comprise and/or refer to frequency-related information, in particular regarding one or more carriers and/or bandwidth and/or subcarriers and/or time-related information, in particular regarding frames and/or slots and/or subframes, and/or regarding resource blocks and/or time/frequency hopping information.

A resource element may generally describe the smallest individually usable and/or encodable and/or decodable and/or modulatable and/or demodulatable time-frequency resource, and/or may describe a time-frequency resource covering a symbol time length in time and a subcarrier in frequency. A signal may be allocatable and/or allocated to a resource element. A subcarrier may be a subband of a carrier, e.g. as defined by a standard. A carrier may define a frequency and/or frequency band for transmission and/or reception.

In this disclosure, for purposes of explanation and not limitation, specific details are set forth (such as particular network functions, processes and signaling steps) in order to provide a thorough understanding of the technique presented herein. It will be apparent to one skilled in the art that the present concepts and aspects may be practiced in other embodiments and variants that depart from these specific details.

For example, the concepts and variants are partially described in the context of Long Term Evolution (LTE) or LTE-Advanced (LTE-A) or Next Radio (NR) mobile or wireless communications technologies; however, this does not rule out the use of the present concepts and aspects in connection with additional or alternative mobile communication technologies such as the Global System for Mobile Communications (GSM). While the following embodiments will partially be described with respect to certain Technical Specifications (TSs) of the Third Generation Partnership Project (3GPP), it will be appreciated that the present concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the embodiments described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. The aspects presented herein can be varied in many ways.

Some useful abbreviations comprise:

| Abbreviation | Explanation |
|---|---|
| 5G | 5^{th} Generation |
| TDD | Time division duplexing |
| RS | Reference signal |
| UE | User equipment |
| SIR | Signal-to-Interference-Ratio |
| SINR | Signal-to-Interference-and-Noise-Ratio |
| SNR | Signal-to-noise-ratio |
| NR | New radio, a 3 GPP standard |
| RAN | Radio Access Network |
| LTE | Long Term Evolution, a 3 GPP standard |

1-17. (canceled)

18. A method for operating a first radio node in a radio access network, the method comprising performing, by the first radio node, a calibration of the first radio node based on calibration signaling received from a second radio node and based on calibration configuration information, the calibration configuration information being received from the second radio node.

19. The method according to claim 18, wherein the calibration configuration information indicates transmission characteristics of the calibration signaling and/or the second radio node.

20. The method according to claim 18, further comprising transmitting, to the second radio node, a calibration request.

21. The method according to claim 18, further comprising transmitting, to the second radio node, calibration setup information pertaining to the first radio node.

22. A first radio node for a radio access network, the first radio node comprising:
radio circuitry; and
processing circuitry configured to perform a calibration of the first radio node based on calibration signaling received from a second radio node and based on calibration configuration information, the calibration configuration information being received from the second radio node.

23. The first radio node according to claim 22, wherein the calibration configuration information indicates transmission characteristics of the calibration signaling and/or the second radio node.

24. The first radio node according to claim 22, wherein the processing circuitry is configured to transmit, to the second radio node, a calibration request.

25. The first radio node according to claim 22, wherein the processing circuitry is configured to transmit, to the second radio node, a calibration setup of the first radio node.

26. A method for operating a second radio node in a radio access network, the method comprising transmitting calibration configuration information from the second radio node to a first radio node.

27. The method according to claim 26, wherein the calibration configuration information indicates transmission characteristics of calibration signaling transmitted from the second radio node to the first radio node and/or of the second radio node.

28. The method according to claim 26, further comprising transmitting, to the first radio node, calibration signaling according to a calibration configuration the calibration configuration information pertains to.

29. The method according to claim 26, further comprising transmitting, to the first radio node, a calibration confirmation indication, in response to a calibration request received from the first radio node.

30. A second radio node for a radio access network, the second radio node comprising:
radio circuitry; and
processing circuitry configured to transmit calibration configuration information to a first radio node.

31. The second radio node according to claim 29, wherein the calibration configuration information indicates transmission characteristics of calibration signaling transmitted from the second radio node to the first radio node and/or of the second radio node.

32. The second radio node according to claim 29, wherein the processing circuitry is configured to transmit, to the first radio node, calibration signaling according to a calibration configuration the calibration configuration information pertains to.

33. The second radio node according to claim 29, wherein the processing circuitry is configured to transmit, to the first radio node, a calibration confirmation indication, in response to a calibration request received from the first radio node.
